(19) United States
(12) Patent Application Publication
(10) Pub. No.: US 2014/0106623 A1
(43) Pub. Date: Apr. 17, 2014

(54) TRANSFER PLUG FOR A VARIETY OF SOCKETS

(71) Applicant: HON HAI PRECISION INDUSTRY CO., LTD., New Taipei (TW)

(72) Inventors: Zhuang-Zhi WU, Kunshan (CN); Xue-Chao WANG, Kunshan (CN)

(73) Assignee: HON HAI PRECISION INDUSTRY CO., LTD., New Taipei (TW)

(21) Appl. No.: 14/039,165

(22) Filed: Sep. 27, 2013

(30) Foreign Application Priority Data
Oct. 15, 2012 (CN) 201210389141.8

(51) Int. Cl. H01R 31/06

(52) U.S. Cl. CPC H01R 31/06
USPC 439/638

(57) ABSTRACT

A transfer plug (100) includes a first plug (2) and a second plug (3) pivoted with the first plug. The first plug includes a first insulative body (21) and a first connector (22), a second connector (23) immovably and respectively assembled to two opposite ends of the first insulative body. The second plug includes a second insulative body (31), a third connector (32) retractably exposed out of a front part of the second insulative body, and a button (33) assembled to the second insulative body. The first connector and the second connector are permanently connected with each other and the third connector is detachably connected with the second connector via operating the button.

### BACKGROUND OF THE INVENTION

1. Field of the Invention

The present invention relates generally to a transfer plug for a variety of sockets, and more particularly to such a plug that is user-friendly.

2. Description of Related Arts

Users usually employ a variety of transfer plugs for engaging with various sockets in different kinds of electrical devices, such as notebook, mobile phone, digital camera, DVD, PDA, MP3, MP4, GPS, etc. Since the multifarious transfer plugs bring inconvenience to the user, a transfer plug capable of engaging with a variety of sockets has been invented.

U.S. Pat. No. 7,473,141 discloses such a transfer plug. The transfer plug includes an insulating shell, a first connector, a second connector, and a signal plug. The insulating shell has two side arms and first pivoted portions. The first and the second connectors are respectively mounted to the insulating shell and are electrically connected. The signal plug movably connects to the insulating shell and has a third connector for connecting to the second connector. The signal plug has a gliding groove in a lateral edge thereof for engaging with the pivoted portion. The insulating shell is combined with the first and second connector to form a transitioning plug. The signal plug can slidably move and pivot in different directions to an independent usable state. The signal plug, therefore, can be used alone without the need to disassemble the transitioning plug. More than on transitioning plug can be cascaded to form a multitasking transfer plug for different specifications and types of sockets. However, there is not any positive fastening means to safeguard the connection between the second connector and the third connector. U.S. Pat. No. 7,556,535 discloses a locking button cooperating with the shell side arms to provide a positive connection between the second connector and the third connector.

A transfer plug that is user-friendly for engaging with a variety of sockets is desired.

### SUMMARY OF THE INVENTION

Accordingly, an object of the present invention is to provide a transfer plug user-friendly for engaging with a variety of sockets.

To achieve the above object, a transfer plug includes a first plug and a second plug pivoted with the first plug. The first plug includes a first insulative body and a first connector, a second connector immovably and respectively assembled to two opposite ends of the first insulative body. The second plug includes a second insulative body, a third connector retractably exposed out of a front part of the second insulative body, and a button assembled to the second insulative body for actuating the third connector. The first connector and the second connector are permanently connected with each other and the third connector is detachably connected with the second connector via operating the button.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of a transfer plug according to the present invention when the transfer plug is in a first usable state;

FIG. 2 is a perspective, exploded view of the transfer plug;

FIG. 3 is another perspective, exploded view of the transfer plug;

FIG. 4 is a perspective, assembled view of the transfer plug in a second usable state; and

FIG. 5 is perspective, assembled view of the transfer plug in a third usable state.

### DETAILED DESCRIPTION OF THE PREFERRED EMBODIMENT

Reference will now be made in detail to the preferred embodiment of the present invention.

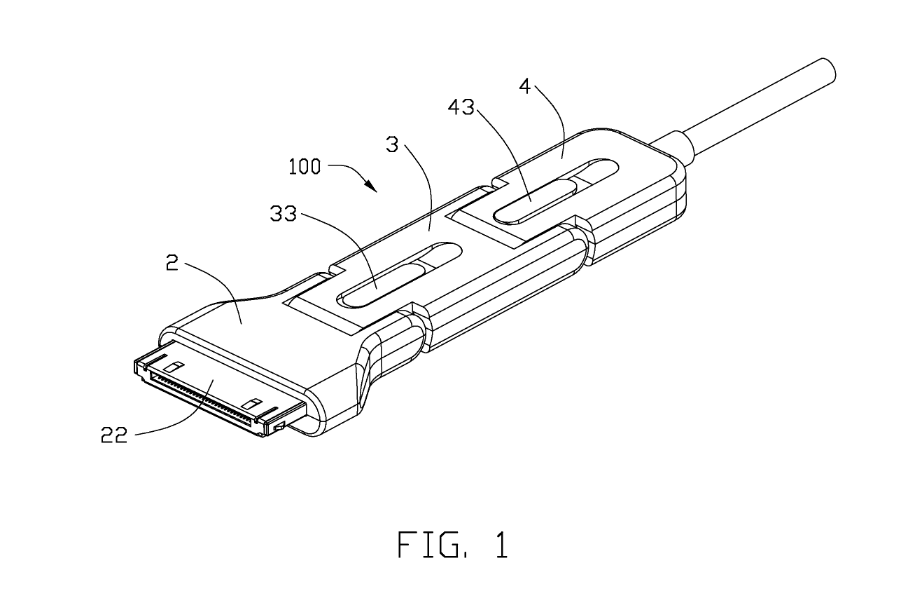

Referring to FIGS. 1 to 5, a transfer plug 100 comprises a first or option plug 2, a second or option plug 3, and a third or basis plug 4. The first plug 2 is pivoted to the second plug 3 and the second plug 3 is pivoted to the third plug 4 so as to combine the multitasking transfer plug 100 which engages with variety sockets of different kinds of electrical devices, such as notebook, mobile phone, digital camera, DVD, PDA, MP3, MP4, GPS, and etc.

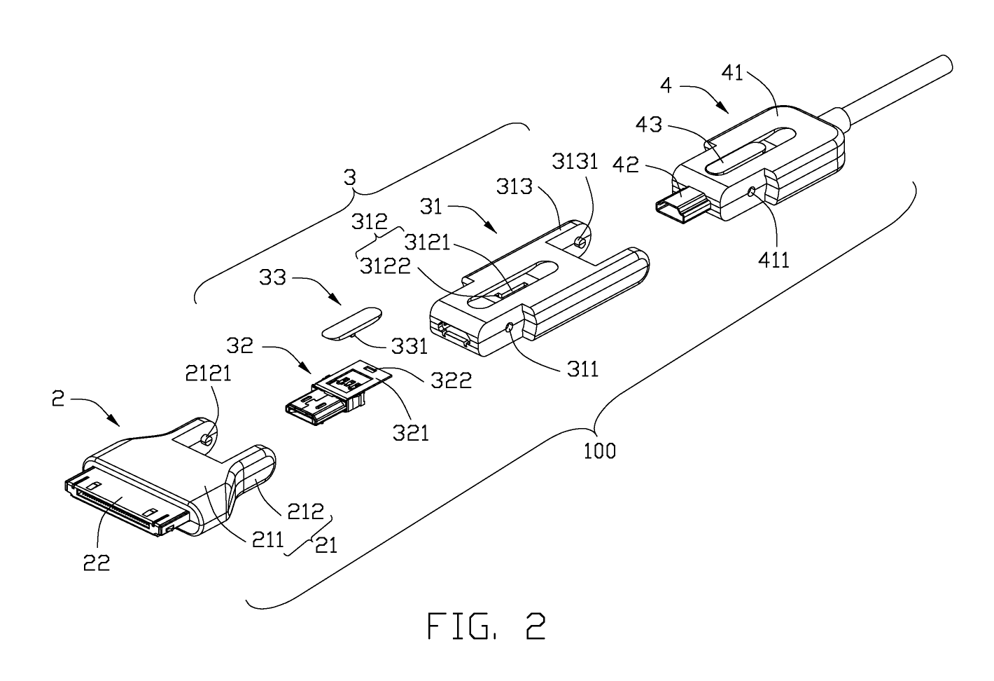

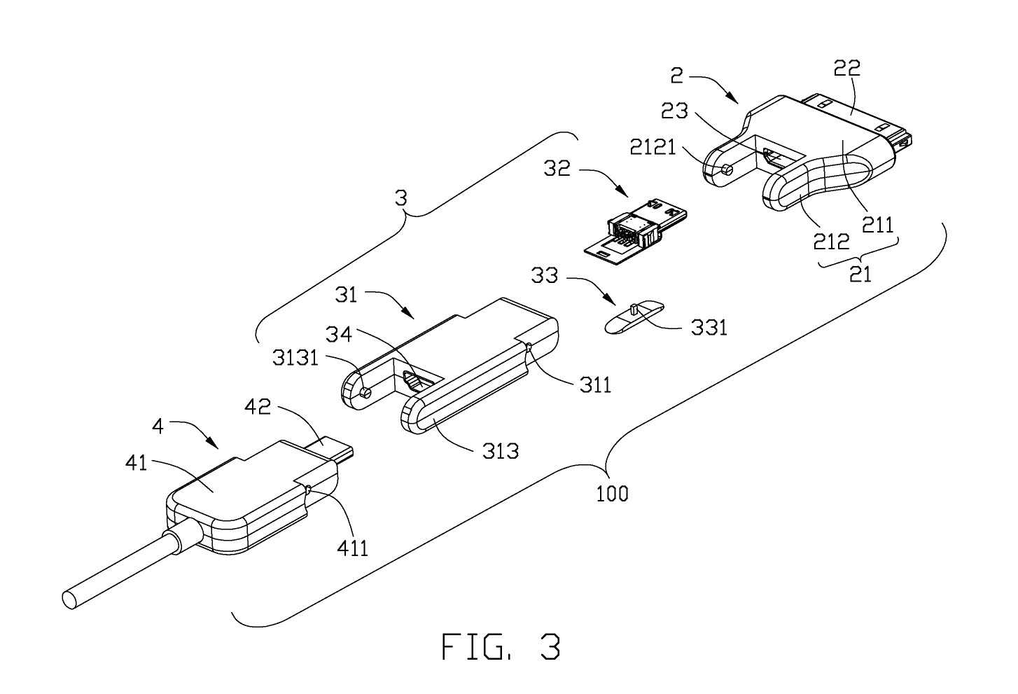

Referring to FIGS. 2 and 3, the first plug 2 comprises a first insulative body 21 and a first connector 22, a second connector 23 immovably and respectively assembled to two opposite ends of the first insulative body 21. The first insulative body 21 comprises a main body 211 and a pair of first arms 212 extending laterally and rearwardly from the main body 211. The first connector 22 is exposed out of a front part of the main body 211 while the second connector 23 is received in a rear part of the main body 211. The first connector 22 and the second connector 23 are permanently electrical connected with each other. Each first arm 21 forms a pivoting portion 2121 at each lateral inner edge thereof

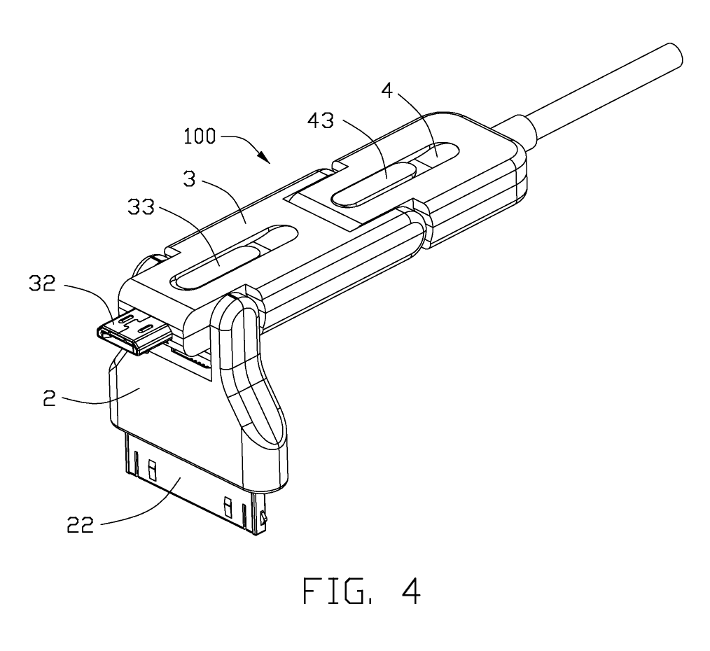

Referring to FIGS. 1-5 and particularly referring to FIGS. 1 and 4, the second plug 3 comprises a second insulative body 31, a third connector 32 retractably exposed out of a front part of the second insulative body 31, and a button 33 assembled to the second insulative body 31 for actuating the third connector 32. The second insulative body 31 defines a pair of round apertures 311 correspondingly receiving the pivoting portions 2121 and therefore, the second plug 3 is pivoted with the first plug 2 only but a distance between the first insulative body 21 of the first plug 2 and the second insulative body 31 of the third plug 3 is invariant. The third connector 32 is detachably connected with the second connector 23, although. In a first use state as shown in FIG. 1, the third connector 32 extends out of the second insulative body 31 and is engaged with the second connector 23 for electrical connection therebetween. The second insulative body 31 defines an L-shaped slot 312 having a lengthwise slot 3121 and a transverse slot 3122 vertically and laterally extending from a front part of the lengthwise slot 3121. The third connector 32 comprises a metal shell 321 with a cutout 322 defined therein. The button 33 comprises an actuating portion 331 moveably guided by the lengthwise slot 3121 and the transverse slot 3122. The actuating portion 331 is further secured in the cutout 322 of the metal shell 321 of the third connector 32. The cutout 322 has a first length along a mating direction and a second length along a transverse direction perpendicular to the mating direction. The first length is smaller than the second length and make sure that the actuating portion 331 is immovable along the mating direction and movable along the transverse direction, with respect to the third connector 32. Therefore, the button 33 is capable of actuating the third connector 32 with respect to the second insulative body 31. For other use consideration, the third connector 32 is retracted into the second insulative body 31 when the button 33 is operated to make sure that the actuating portion 331 moves from the transverse slot 3122 to the lengthwise slot 3121. Because the third connector 32 is dissembled away from the first insulative body 21, the first plug 2 is rotatable with respect to the second plug 3. Finally, the third connector 32 extends out of the second insulative body 31 again for independently engaging with some kind of socket as shown in FIG. 4 by operating the button 33 to make sure that the actuating portion 331 moves from the lengthwise slot 3121 to the transverse slot 3122, again.

Referring to FIGS. 1-3 and 5, the second plug 3 further comprises a fourth connector 34 immovably received in a rear part of the second insulative body 31 and a pair of second arms 313 extending laterally and rearwardly from the second insulative body 31. The third connector 32 and the fourth connector 34 are permanently electrical connected with each other because coiled wires (not shown) are directly connected therebetween. Therefore, when the third connector 32 moves outwards relative to the second insulative body 31, the coiled wires are straighten for maintaining the electrical connection between the third connector 32 and the fourth connector 34. Each second arm 313 forms a second pivoting portion 3131 at each lateral inner edge thereof

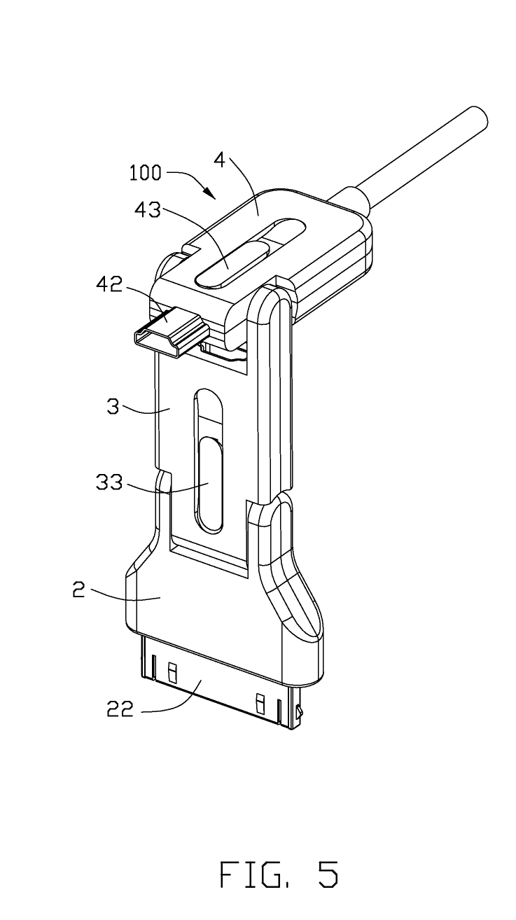

Referring to FIGS. 1-5, the third plug 4 comprises a third insulative body 41, a fifth connector 42 retractably exposed out of a front part of the third insulative body 41, and a second button 43 assembled to the third insulative body 41 for actuating the fifth connector 42. The fifth connector 42 is detachably connected with the fourth connector 34. The third insulative body 41 defines a pair of second round apertures 411 correspondingly receiving the second pivoting portions 3131. The second button 43 has a same structure as the button 33. A user operates the second button 43 and the fifth connector 42 is retractable with respect to the third insulative body 41. Therefore, the second plug 3 is rotatable with respect to the third plug 4. The fifth connector 42 extends out of the third insulative body 41 again for independently engaging with some kind of socket as shown in FIG. 5.

The pivoting portions 211 and the round apertures 311 can change their relative locations to achieve a pivoting function. So can the second pivoting portion 3131 and the second round apertures 411. Similar structures equal to the pivoting portions 211 and the round apertures 311 are inclusive by this present invention.

The first connector 22, the third connector 32, and the fifth connector 42 are different plug connectors, the second connector 23 and the fourth connector 33 are different receptacle connectors, i.e., in this embodiment, the first connector 22 is a 30 pin I/O plug connector, the second connector 23 is a micro USB receptacle connector, the third connector 32 is a micro USB plug connector, the fourth connector 33 is a min USB receptacle connector, and the fifth connector 42 is a mini USB plug connector.

The third insulative body 41 is changeable by adding a pivoting structure for converting into a multitasking transfer plug with different specifications and types of sockets.

Because the transfer plug 100 has at least two plug connectors 22, 32, 42, it is multitasking for engaging with different specifications and types of sockets. The transfer plug 100 includes button structures 33, 43 for actuating the third connector 32 and the fifth connector 42 which is convenient in operation of the transfer plug 100. Overall, the transfer plug 100 is portable and user-friendly.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A transfer plug comprising:
a first plug comprising a first insulative body, a first connector assembled to one end of the body, and a second connector assembled to an opposite end of the body; and
a second plug pivoted to the first plug, the second plug comprising a second insulative body, a third connector movably mounted to and retractably exposed out of a front part of the second insulative body, and a button assembled to the second insulative body;
wherein the first connector and the second connector are permanently electrically connected with each other, and the third connector is detachably connected with the second connector via operating the button.

2. The transfer plug as claimed in claim 1, wherein the third connector comprises a metal shell with a cutout defined therein and the button has an actuating portion secured in the cutout.

3. The transfer plug as claimed in claim 2, wherein the actuating portion is immovable along a mating direction defined by the second connector and the third connector, and movable along a transverse direction perpendicular to the mating direction, with respect to the third connector.

4. The transfer plug as claimed in claim 3, wherein the cutout has a first length along the mating direction and a second length along the transverse direction and the first length is smaller than the second length.

5. The transfer plug as claimed in claim 2, wherein the second insulative body defines an L-shaped slot having a lengthwise slot and a transverse slot vertically and laterally extending from the lengthwise slot, and the actuating portion is moveably guided by the lengthwise slot and the transverse slot.

6. The transfer plug as claimed in claim 1, wherein a distance between the first insulative body of the first plug and the second insulative body of the third plug is invariant.

7. The transfer plug as claimed in claim 6, wherein one of the first insulative body and the second insulative body forms a pair of pivoting portions and the other one of the first insulative body and the second insulative body defines a pair of round apertures correspondingly receiving the pivoting portions.

8. The transfer plug as claimed in claim 7, wherein the first insulative body has a main body and a pair of arms extending laterally from the main body and the pivoting portions are formed on lateral inner edges of the arms while the round apertures are defined on the second insulative body.

9. The transfer plug as claimed in claim 1, further comprising a third plug pivoted with the second plug.

10. The transfer plug as claimed in claim 9, wherein the second plug comprises a fourth connector assembled to the second insulative body and permanently connected with the third connector, the third plug comprises a third insulative body, a fifth connector retractably exposed out of the third insulative body, and a second button assembled to the third insulative body, the fifth connector is detachably connected with the fourth connector via operating the second button.

11. A combo plug assembly for use with different first and second complementary sockets, comprising:
a first plug performing as a basis plug and include a first housing with a first front mating port and a first rear connecting port along a front-to-back direction, the first rear connecting port connected to a cable; and
a second plug performing as an option plug and include a second housing with e a second front mating port and a second rear connection port along the front-to-back direction, the second rear connecting port adapted to optionally mated with the first front mating port; wherein
at least either the first front mating port is linearly moveable relative to the first housing in the front-to-back direction or the second rear connecting port is linearly moveable relative to the second housing in said front-to-back direction for mating with each other; wherein
the second housing is located in front of the first housing, and the first housing and the second housing are arranged with each other, around said first front mating port and said second rear connecting port, in a pivotal manner without involvement with relative linear movement therebetween; wherein
when the first complementary socket is available, the first front mating port is exposed to an exterior for use with the first complementary socket under a situation that the second front mating port is unused and the second rear connecting port is not mated with the first front mating port but in a spatial neighboring manner; alternately, when the second complementary socket is available, the second front mating port is exposed to the exterior for use with the second complementary socket under a situation that the first front mating port and the second rear connecting port are coupled with each other to establish an electrical path between the cable and the second front mating port.

12. The combo plug assembly as claimed in claim 11, wherein said first housing is hinged to the second housing with a common pivot shaft thereof

13. The combo plug assembly as claimed in claim 12, wherein said pivot shaft extends in a transverse direction perpendicular to the front-to-back direction, and each of the first housing and second housing defines a cross-section with a pair of opposite long sides and a pair of short sides, said long sides extending along said transverse direction.

14. The combo plug assembly as claimed in claim 11, wherein said first front mating port is linear moveable relative to the first housing in the front-to-back direction.

15. The combo plug assembly as claimed in claim 14, wherein the second housing defines a pair of arms sandwiching the first housing in a transverse direction perpendicular to said front-to-back direction.

16. The combo plug assembly as claimed in claim 11, further including a third plug performing as another option plug and located in front of the second plug in a pivotal manner, wherein said third plug including a third housing with a third front mating port and a third rear connecting port, and at least either the third rear connecting port is linear moveable relative to the third housing in the front-to-back direction or the second front mating port is linear moveable relative to the second housing for not only relative rotation between the second housing and the third housing without interference but also mechanical and electrical coupling between the second front mating port and the third rear connecting port with reliability.

17. A method of selectively mating a cable assembly with at least first and second different complementary sockets, comprising steps of:
providing a first plug with a first housing retaining a first front mating port and a first rear connecting port in a front-to-back direction;
providing a cable connected to the first rear connecting port;
providing a second plug with a second housing retaining a second front mating and a second rear connecting port in the front-to-back direction; wherein the second housing is assembled to the first housing in a pivotal manner without linear movement therebetween, and the first front mating port is matable with the second rear connecting port, and at least either the first mating port is linearly moveable relative to the first housing in the front-to-back direction or the second rear connecting port is linearly moveable relative to the second housing in the front-to-back direction;
when the first complementary socket is available, the second rear connecting port is unmated with the first front mating port and the second housing is angled with regard to the first housing to allow the first front mating port to be coupled to the first complementary socket linearly in the front-to-back direction; alternately, when the second complementary socket is available, the second rear connecting port is mated with the first front mating port to create an electrical path between the cable ant the second front mating port to allow the second front mating port to be electrically coupled to the second complementary socket under condition that the first housing and the second housing are linear with each other in the front-to-back direction.

18. The method as claimed in claim 17, wherein the first housing and the second housing share a same pivotal shaft.

19. The method as claimed in claim 18, wherein said pivotal shaft extends in a transverse direction perpendicular to said front-to-back direction, and the first front mating port defines a long side and a short side perpendicular to each other and the long side extends along said transverse direction.

20. The method as claimed in claim 17, wherein the first front mating port is linearly moveable relative to the first housing.
